(19) United States
(12) Patent Application Publication
(10) Pub. No.: US 2004/0038144 A1
(43) Pub. Date: Feb. 26, 2004

(54) Electrophotographic carrier core magnetite powder

(76) Inventors: Lars Hultman, Viken (SE); Rose-Marie Yttergen, Helsingborg (SE); Fredrik Eklund, Helsingborg (SE); Nils Jonsson, Angelholm (SE)

Correspondence Address: BURNS DOANE SWECKER & MATHIS L L P, POST OFFICE BOX 1404, ALEXANDRIA, VA, 22313-1404, US

(21) Appl. No.: 10/432,242

(22) PCT Filed: Sep. 26, 2002
(86) PCT No.: PCT/SE02/01757

(30) Foreign Application Priority Data
Sep. 28, 2001 (SE) 0103263-0
Sep. 28, 2001 (SE) 0103264-8

(51) Int. Cl. G03G 9/113

(52) U.S. Cl. 430/111.31; 430/137.13

(57) ABSTRACT

A carrier core material having a voltage breakdown of at least 300V, essentially consisting of a magnetite base powder, the particles of which are surrounded by an electrically insulating coating essentially free from organic material.

### FIELD OF THE INVENTION

This invention relates to particulate magnetite materials useful as a carrier component in electrophotographic developers, in particular two-component developers comprising the carrier component together with a toner component.

### BACKGROUND OF THE INVENTION

In electrophotography, the electrostatic image formed on the photoconductor is developed by the magnetic brush method using either the so called “one-component” developer or “two-component” developer. Usually, the two-component developer system comprises a mixture of relatively fine particles of a toner and relatively coarse particles of a carrier. The toner particles are held on the carrier particles by the electrostatic forces of opposite polarities which are generated by friction of the particles. When the developer comes into contact with an electrostatic latent image formed on the photosensitive plate, the toner particles are attracted by the image and thus make the latter visible. The thus developed image is then transferred onto a recording medium, such as a paper sheet. In the process, therefore, the toner particles should be charged with an accurately controlled amount of static electricity so that they are preferentially attracted to the electrostatically imaged area of the photosensitive plate.

This, in turn, means that the carrier which is used in combination with the toner must have an appropriate triboelectric property which enables it to electrostatically hold the toner particles and to transfer the held toner particles to the electrostatic latent image on the photosensitive plate when contacted. Additionally the carrier particles should have a sufficient mechanical strength to protect the carrier particles from breaking or cracking. These particles should also exhibit a good fluidity, be uniform in their electric and magnetic properties and be stable with respect to changes in the environmental conditions, such as humidity. The carrier particles should have a sufficient durability to ensure an acceptable lifetime.

In the most recent printing technology, which permits improved quality and speed, the distance between magnetic brush and photoreceptor is smaller and currents during printing are higher, a consequence of which is that the carrier core itself must be able to carry some of the amount of current in the copying process. More specifically higher voltage breakdown of the carrier core itself is needed. Preferably this higher voltage breakdown should not be accompanied by a higher resistivity, but rather with a medium high resistivity.

The carrier core materials normally used when high voltage breakdown values are required are selected from ferrites. These compounds have the chemical formula Fe₂MO₄ wherein M can be Mn, Fe, Co, Ni, Cu, Zn, Cd, Mg. In order to meet different requirements depending on the specific type of copiers and printers used, i.e. the chemical composition of the ferrite has to be changed. A problem is thus that, in order to obtain ferrite powders having optimal properties, it is often necessary to manipulate the chemistry of these ferrite base powders so as to include different types of oxides of heavy metals. Such metals should however to the outmost possible extent be avoided as they are detrimental to the environment. Thus there is an increasing demand of a carrier core material which has a high voltage breakdown and which does not pollute the environment.

The most simple of the ferrites is the compound wherein M is Fe, i.e. the compound having the formula Fe₃O₄, commonly called magnetite. Magnetite is not environmentally detrimental, but the voltage breakdown is low, normally between 30-50 V. This is an indication that it would not be possible to use magnetite in the most recent printing technology.

It has now unexpectedly been found that by a comparatively simple process it is possible to use magnetite as a base material for the preparation of new carrier core materials having not only high voltage breakdown but which also in other respects can be tailored in order to meet different needs.

### SUMMARY OF THE INVENTION

In brief the new carrier core material essentially consists of a magnetite base powder, the particles of which are surrounded by an electrically insulating coating consisting of an inorganic material. More specifically the inorganic material should be such that the resitivity of the coated particles is higher than that of the magnetite base particles.

The invention also concerns a method for the preparation of such a new carrier core material.

### DETAILED DESCRIPTION OF THE INVENTION

The spherical magnetite base powder may be produced as described in the U.S. Pat. No. 4,663,262 which is hereby incorporated by reference. According to this patent the magnetite base is produced from natural magnetite by the following general procedure:

A magnetite powder is formed into agglomerates which are then calcined at a predetermined temperature under a specific atmosphere. The calcined granules are suitably cracked or dispersed and then classified into a desired size distribution. As the agglomerates are formed with a binder material which is effective for reducing the raw magnetite (Fe₃O₄) to wustite (FeO), the magnetite is partially converted to wustite during the calcination to give a product magnetite usually containing 15-20% of wustite. By controlling the temperature and the composition of the atmosphere during the cooling step after the calcinations magnetite powders containing less than 10%, preferably less than 3%, by weight of wustite may be obtained.

The magnetite base material could of course be obtained from other sources such as synthetic sources. Furthermore the magnetite base preferably consists of at least 70% of magnetite. Minor amounts i.e. up to 30% by weight of other compounds, such as hematite, wustite, silicon, metallic iron, phosphorus, aluminia, titanium oxide, or inert inorganic or organic materials may be included in the particulate magnetite base material.

Furthermore, according to an embodiment of the invention, powders having particles with essentially spherical shape are preferred as such powders have isotropic magnetic properties which are advantageous in many xerographic applications. The particle size of the base material used according to the present invention is normally between 15 and 200 μm. Typical examples of such substantially spherical magnetite base powders which may be used are magnetite powders of the CM series from Höganäs AB, Sweden.

The coating on the particles of the ferromagnetic powder of the present invention should preferably exhibit a number of properties. Thus, the coating should be insoluble in water and organic solvents. Furthermore, the coating should not have a negative influence on powder properties, such as apparent density and flow. This means that the apparent density of the new carrier core powder should preferably vary between about 1 and 4 g/cm³ and the flow between 20 and 25 s/50 g. Furthermore, the inorganic insulating coating should completely cover the individual ferrite base particles. The coating should be coherent, homogenous and uniform and not contain organic material. An important feature of the coating is that it does not affect the magnetic properties of base powder, from which follows that the magnetic properties of the insulated powder particles are essentially the same as those of the base powder. Typical values for magnetic properties of suitable base powders are for saturation σs, 90-96 emu/g, for remenence, σr, <3 emu/g and for coercivity, H_{c}<30 Oe. Most importantly, the coating should impart high voltage breakdown as well as other properties to the carrier core materials required for modern xerographic applications.

According to the present invention the coating might be based on an inorganic compound such as an inorganic oxide, nitride or carbide, acetate. Typical examples of inorganic compounds manganese dioxide, boron trioxide, tin oxide, silicon dioxide, vanadium oxide, titanium oxide, zirconium dioxide, molybdenum oxide, magnesium oxide, aluminium oxide and yttrium oxide. Any one of these materials or a mixture of two or more of them can be used.

According to a preferred embodiment of the inorganic coating is obtained by mixing the magnetite base powder with an aqueous solution of phosphoric acid. The amount and concentration of the phosphorus acid is decided by the desired final properties of the insulated powder. Typically the amount of coating solution may range between 20 and 80 ml per kg magnetite powder and the thickness may preferably vary within about 0.1 to about 5 μm. The coating solution may include other elements in order to obtain a coating layer which in addition to phosphorus also includes elements such as Ti, Al, Zr, Mg which may be advantageous for certain applications. Another preferred coating is obtained when the magnetite powder is treated with magnesium acetate and subsequently heat treated (300-700° C.).

According to the present invention insulated particles having very high voltage breakdown values, such as up to 1000 V or even higher may be obtained whereas values below about 500 V are less important for modern printing technology. For some applications, however, voltage breakdown values as low as 300 V are of interest. The resistivity of the insulated particles preferably varies between about 10⁸ and 10¹⁰.

EP 955567 discloses surface modified magnetite particles. According to this patent publication the particles having an average particle diameter of about 0.02-0.5 μm are covered with a first layer of hydrated aluminna or alumina sol and the surface of the first layer is coverd with a second layer of silica particles. The particles are useful as toners.

The U.S. Pat. No. 4,925,762 discloses carriers for a two-component dry developer are based on a ferrite or iron-containing core which carries a metal oxide layer consisting of reaction products deposited in the gas phase. Specifically disclosed are layers of iron oxide and titanium dioxide on particles of ferrite or iron.

According to the U.S. Pat. No. 5,534,378 carriers for electrophotography are based on magnetic cores coated with a first layer A) of different metal oxides, which essentially consists of electrically insulating metal oxide and a second layer B) which essentially consists of metal oxide controlling the electrostatic charging of the toner and which does not substantially decrease the electroresistance of the carriers, which resistance is provided by the layer (A). The cores may consist of e.g. iron, steel, magnetite, ferrite, cobalt or nickel. Titanium dioxide, alumina, iron oxide and especially silica, as well as mixtures thereof, are particularly suitable for the first, electrically insulating metal oxide layer (A).

Several patents such as the U.S. Pat. Nos. 4,233,387, 4,963,455, 4,937,166 disclose carrier core particles coated with organic polymeric materials. According to the present invention, in contrast, the insulating layer is free from organic material.

The insulated carrier core particles according to the present invention are subsequently coated with a thin resinous layer in order to produce a carrier material. This layer is needed e.g. in order to adjust the tribo and increase life. The amount of this organic or resinous layer is normally between about 1.5 to 6% by weight of the carrier core.

The invention is further illustrated by the following non limiting examples.

### EXAMPLE 1

The base material in the following examples is CM 70, a spherical magnetite with a mean particle size of 70 μm available from Höganäs AB Sweden.

A coating solution was obtained by dissolving various amounts of ortophosphorous acid in water. The coating solutions were thoroughly mixed just before they were added to the magnetite powders in order to avoid segregation. The coating solutions were added to the powder with a rate of 25 mg per kg powder for a period of 90 s. The obtained mixture was thoroughly mixed while the temperature was maintained between 80 and 90° C. The solution was then evaporated leaving the insulated particles as a residue. As a last step the dried powder was sieved in order to eliminated oversized particles and agglomerates.

The following results were obtained:

TABLE 1

| Coating | Amount of | | |
|---|---|---|---|
| solution | Coating | | Voltage |
| (% phosphoric | Solution | Resistivity* | Breakdown* |
| acid) | (ml) | (Ωcm) | (V) |
| 30 | 25 | 8.7 * 10⁹ | 550 |
| 30 | 50 | 4.4 * 10⁹ | >1000 |
| 30 | 75 | 4.3 * 10⁹ | >1000 |
| 46 | 25 | 6.3 * 10⁹ | >1000 |
| 46 | 50 | 6.3 * 10⁹ | >1000 |
| 46 | 75 | 4.7 * 10⁹ | >1000 |
| —** | — | 7 * 10⁷ | 40 |

*The electrical resistance and the voltage breakdown of the carrier cores was measured using the C meter from PES Laboratory (Dr. R. Epping, Neufahrn).
**Uncoated reference, CM 70
As can be seen from the results the inorganic coating increases the resistivity of the carrier core material.

### EXAMPLE 2

In this example a base magnetite powder CM 40 was used. This powder was subjected to an oxidation treatment as suggested in the U.S. Pat. No. 4,663,262. Part of the obtained oxidised powder (=Sample CM40A) was provided with an inorganic coating (=Sample CM40B) according to the present invention. As can be seen from the Table 2 below, the resistivity is increased by the oxidation treatment. However the voltage breakdown is considerably lower than that of the coated powder according to the present invention.

TABLE 2

| | Resistivity* | Voltage breakdown* |
|---|---|---|
| | (Ωcm) | (V) |
| CM40 A oxidised | 2.2 * 10⁹ | 425 |
| CM40 B | 1.1 * 10¹⁰ | 700 |
| CM40 (ref.) | 7 * 10⁷ | 40 |

*The electrical resistance and the voltage breakdown of the carrier cores was measured using the C meter from PES Laboratory (Dr. R. Epping, Neufahrn).

As can be seen from the results in the above table 2 the electrical properties are considerably improved by using an inorganic coating according to the present invention. Thus, the voltage breakdown can reach high values which are comparable to those of ferrites. An unexpected effect is that the high voltage breakdown properties do not necessary involve high resitivity of the carrier cores. High resistivity of the carrier cores is not desired as the amount of toner per carrier is decreased when the resistivity is increased. Additionally the improvements in the electrical properties do not affect other properties such as magnetic properties of the carrier cores.

### EXAMPLE 3

The base material used in this example was CM 70. 50 ml of a solution prepared by dissolving 350 mg Mg acetate in 1000 g water were added to 1 kg CM 70 according to a procedure similar to that of exemple 1. The obtained powders, designated Sample A, B and C were heat treated for 30 minutes as follows:

TABLE 3

| Sample | Base powder | Heat treatment ° C. |
|---|---|---|
| A | CM 70 | 300 |
| B | CM 70 | 500 |
| C | CM 70 | 700 |

The following data were obtained. A CM70 powder without inorganic coating was used as a reference.

TABLE 4

| | | | | σs | σs | | |
|---|---|---|---|---|---|---|---|
| | AD | Flow | Res | 10 kOe | 1 kOe | σr | Hc |
| Sample | (g/cm³) | (s/50 g) | (Ωcm) | (emu/g) | (emu/g) | (emu/g) | (Oe) |
| A | 2.51 | No | >10¹⁰ | | | | |
| B | 2.56 | No | >10¹⁰ | 93 | 74 | 1.8 | 17 |
| C | 2.66 | 24 | 2*10⁸ | | | | |
| CM70 | 2.58 | 22 | 5*10⁷ | 93 | 70 | 1.8 | 15 |

3 additional samples D, E and F according to the following table were prepared.

TABLE 5

| Sample | Base powder | Heat treatment ° C. |
|---|---|---|
| D | CM 70 | 150 |
| E | CM 70 oxidised | 150 |
| F | CM 70 oxidised | 500 |

These samples were tested along with Sample C and the following results were obtained:

TABLE 6

| | 105BC | 105AD | 92AE | 92F |
|---|---|---|---|---|
| AD | | 2.46 | 2.40 | |
| (g/cm³) | | | | |
| Flow | | 26.6 | 28.4 | |
| (s/50 g) | | | | |
| SSA | 376 | 465 | 473 | 387 |
| (m²/kg) | | | | |
| σs 10kOe | 93 | 91 | 89 | 89 |
| (emu/g) | | | | |
| σs 1kOe | 72 | 71 | 64 | 68 |
| (emu/g) | | | | |
| σr | 2.0 | 2.1 | 2.5 | 2.7 |
| (emu/g) | | | | |
| Hc | 19 | 20 | 29 | 2.9 |
| (Oe) | | | | |
| Fe₂O₃ | | | 2 | 2 |
| (%) | | | | |
| Fe₃O₄ | 100 | 100 | 98 | 98 |
| (%) | | | | |
| VB* | 900 | 280 | 900 | 900 |
| (V) | | | | |
| Res log | 11.2 | 11.6 | 10.6 | 11.4 |
| (logΩcm) | | | | |

*Voltage Breakdown

1. A carrier core material having a voltage breakdown of at least 300V, essentially consisting of a magnetite base powder, the particles of which are surrounded by an electrically insulating coating essentially free from organic material.

2. Carrier core material according to claim 1 essentially consisting of a magnetite base powder, wherein the electrically insulating coating consists of an inorganic material.

3. The carrier core material according to any one of the claims 1-2, wherein the particles of the magnetite base powder are essentially spherical.

4. The carrier core material according to any one of the claims 1 to 3, wherein the magnetite base powder particles include at least 70%, preferably at least 90% of magnetite.

5. The carrier core material according to any one of the claims 1-4, wherein the magnetite base powder particles include hematite, wustite, silicon, metallic iron, phosphorus, aluminia, titanium oxide, or inert inorganic materials.

6. The carrier core material according to any one of the claims 1-5, wherein the size of the insulated particles ranges from about 15 to about 200 μm.

7. The carrier core material according to any one of the claims 1-6, wherein the inorganic coating is essentially coherent, homogenous and uniform.

8. The carrier core material according to any one of the claims 1-7, wherein the thickness of the insulating coating is at least about between 0.1 and 5 μm.

9. Carrier core material according to any one of the claims 1-8, wherein the coating includes an element selected from the group consisting of phosphorus and magnesium.

10. The carrier core material according to any one of the claims 1-9, wherein the inorganic coating also includes elements selected from the group consisting of Ti, Zr, Mg, Al and Si.

11. The carrier core material according to any one of the claims 1-10, wherein the insulating coating includes phosphate.

12. The carrier core material according to any one of the claims 1-11, wherein the insulating coating includes magnesium ferrite.

13. The carrier core material according to any one of the claims 1-12, wherein the insulating coating includes magnesium oxide.

14. The carrier core material according to any one of the claims 1-13 having a voltage breakdown of at least 500V, preferably of at least 700 V.

15. The carrier core material according to any one of the claims 1-14 having a resistivity of between about 10⁸ and 10¹⁰ ohmm.

16. A method of preparing a carrier core powder comprising the steps of:
a) preparing a coating solution by dissolving phosphorus acid in water;
b) adding the obtained solution to a magnetite base powder while mixing;
c) evaporating the solution and drying the obtained powder containing the insulated powder particles.

17. Method according to claim 16, wherein step a) instead entails: preparing a coating solution by dissolving magnesium containing compounds in water.

18. Carrier material consisting of a carrier core material according to any one of the claims 1-15, wherein the insulated particles are provided with a second organic coating applied on the inorganic coating.
